(19) United States
(12) Patent Application Publication
(10) Pub. No.: US 2025/0126683 A1
(43) Pub. Date: Apr. 17, 2025

(54) HEATABLE GARMENT, FABRICS FOR SUCH GARMENTS, AND METHODS OF MANUFACTURE

(71) Applicant: Haydale Graphene Industries PLC, Ammanford, Carmarthenshire (GB)

(72) Inventors: Thomas Harry Howe, Ammanford (GB); Elliot Owen Jones, Ammanford (GB)

(21) Appl. No.: 18/703,082

(22) PCT Filed: Oct. 20, 2022
(86) PCT No.: PCT/EP2022/079288

§ 371 Date: Apr. 19, 2024

(30) Foreign Application Priority Data
Oct. 20, 2021 (GB) 2115023.0

(51) Int. Cl. H05B 3/34; A41D 13/005; C08K 3/04; C09D 5/24; C09D 7/40; C09D 7/61

(52) U.S. Cl. CPC H05B 3/342; A41D 13/0051; C09D 5/24; C09D 7/61; C09D 7/70; C08K 3/042; C08K 2201/001; C08K 2201/011

(57) ABSTRACT

The present invention relates to heating pads, heatable garments, fabrics for making such garments and methods for making such heating pads and garments and fabrics. Also provided is heatable bedding. The heating pad comprises graphene particles dispersed in a polymer matrix material, wherein the graphene particles have an oxygen content of less than 4 at % and a nitrogen content of at least 3 at %. The heatable garment comprises a garment body and a heating pad adhered to at least a portion of the garment body.

### FIELD OF THE INVENTION

The present invention relates to heating pads, heatable garments, fabrics for making such garments and methods for making such heating pads and garments and fabrics. Also provided is heatable bedding.

### BACKGROUND

It is generally desirable to provide new and improved products for generating heat, such as heating pads, for use in various industries such as the automotive industry, construction industry, and clothing industry for applications such as heatable chairs, underfloor heating, as a heat sink for electronics applications, and heatable garments.

By way of example, many of the most popular sporting and leisure pursuits take place in cold environments, which challenge the body's thermoregulatory system. As air temperature drops, this causes vasoconstriction of the blood vessels near the skin's periphery, which reduces blood flow to the skin and in turn causes peripheral blood flow to drop.

As well as causing discomfort, decreased body temperature leads to a reduction in dexterity. For example, it has previously been shown that cooling skin temperature to 13° C. results in a reduction in manual dexterity, and that individuals working in cold environments or handling cold products demonstrate decreased hand function.

This lack of dexterity is of particular significance in sporting applications. For example, in elite sport where a loss in hand dexterity could result in a mistake that could separate success from failure, the importance of maintaining hand skin temperature is clear. In addition, there is a well-reported correlation between muscle temperature, peak power output, repeated exercise ability and subsequent sporting performance. Cold environmental temperatures and periods of low to moderate inactivity, such as experienced following a warmup, while on the side-lines or during breaks in play, can cause a drop in muscle temperature. For example, studies have shown that there is a 4% decrease in leg peak power output for every 1° C. drop in muscle temperature and have demonstrated a strong correlation between core and muscle temperature and performance. These effects are particularly pronounced at extreme low temperatures, such as those experienced at high altitudes and northern/southern latitudes.

Loss of dexterity and muscle performance can also be a significant problem in cold work environments. This is particularly true of jobs involving manual labour, such as construction, shipping, and refrigerated warehouses. To deal with cold environments, it is common for workers to wear thick or multiple layers of clothing. However, this can further exacerbate the loss of dexterity, and can result in decreased levels of productivity, comfort, and safety.

It is known to provide heated garments to try to heat specific areas of the body. For example, WO 2005/119930 describes forming moulded heating elements and attaching them to a garment using adhesive or sewing or holding them within a pocket in the garment (see FIG. 7 of WO 2005/119930). However, the use of moulded heating elements can increase the bulk of the heating elements, negatively impacting the flexibility of garments incorporating such elements.

Another known heated garment is formed by adding conventional wire resistance heaters to clothing. Such garments typically have wires tightly packed in parallel lines across the area to be heated, in so-called “serpentine” paths, so as to spread the supplied heat across the target area. However, as well as being heavy and having high power consumption, these technologies are also susceptible to the creation of hot spots during flexing and general use, limiting the temperatures which these heaters can safely accomplish, their lifetime and general wearability.

It is also known to form heatable garments incorporating woven conductive fibres, which provide resistive heating upon application of a current. The fibres used in such garments typically are either metal (such as copper or nichrome wire), or an insulating material coated in a conductive (e.g. metal) material. Such materials can be difficult and expensive to produce, and the use of such fibres can negatively impact the flexibility and/or stretchability of the garment.

WO 2017/129663 A1, belonging to the present applicant, describes heatable garments, fabrics for such garments, and methods of their manufacture. The garments disclosed therein comprise a heating pad adhered to at least a portion of a garment body, the heating pad comprising graphene particles dispersed in a polymer matrix material.

However, there remains a need to develop improved heatable garments, and fabrics suitable for making such garments.

### SUMMARY OF THE INVENTION

The present inventors have studied various characteristics of graphene particles with particular emphasis on their suitability for use in heatable garments. Traditionally, graphene particles with oxygen functionalisation were considered preferable for providing resistive heating. The reason is that the oxygen functionalisation provided the graphene particles with good dispersibility in the polymer matrix material. However, the inventors have surprisingly found that alternative functionality of the graphene particles can lead to graphene particles not only having excellent dispersibility, but also improved conductivity and, accordingly, improved resistive heating. This finding has formed the basis of the present invention.

In a first aspect, the present invention provides a heating pad comprising functionalised graphene particles dispersed in a polymer matrix material, wherein the graphene particles have a nitrogen content of at least 3 at % and have an oxygen content of less than 4 at %.

In a second aspect, the present invention provides a heatable garment, comprising a garment body and a heating pad adhered to at least a portion of the garment body, wherein the heating pad comprises functionalised graphene particles dispersed in a polymer matrix material, wherein the graphene particles have a nitrogen content of at least 3 at % and have an oxygen content of less than 4 at %.

In further aspects, the present invention provides fabrics for use in the garments, bedding, and methods of making these. Each defines a heating pad according to the first aspect.

Further aspects relate to the use of the heating pads of the invention in applications in various industries such as the sports industry, automotive industry, construction industry, electronics industry, marine industry and clothing industry for applications such as heatable chairs (such as a car seat, aeroplane seat or toilet seat), underfloor heating, as a heat sink for electronics applications, heatable garments and bags (especially sportswear), cooking vessels or appliances, towel warmers. Other uses include application to a substrate such as PET, TPU, paper, rubber, epoxy resin, composites, silicone, glass, ceramics, natural fibres, polyester, nylon, and metals such as steel, for example.

By “adhered” we mean that the heating pad is bonded to the garment body either directly or indirectly. That is, the heating pad is either bonded to the garment body itself without any intermediate layer (i.e. “directly” adhered to the surface), or bonded to the garment body via one or more intermediate layers (i.e. “indirectly” adhered to the surface).

The “heating pad” is an electrical heating pad, i.e. an electrically conductive material which is able to generate heat upon application of an electrical current. The heating pad takes the form of one or more layers adhered to the surface of the garment body.

By “garment body”, we mean the clothing material which forms the structure of the garment, e.g. one or more fabric panels which are connected (e.g. stitched) together into a garment.

The oxygen content and nitrogen content of the functionalised graphene particles of the present invention may be measured by X-Ray Photoelectron Spectroscopy (XPS).

In general, XPS measures surface composition. Accordingly, where oxygen (or nitrogen) content is referred to herein, it applies to measurements of the surface oxygen/nitrogen content (i.e. the value provided by XPS as carried out as described herein).

Herein, we use language such as “nitrogen functionalisation” to refer to nitrogen at the surface of the graphene particles.

The present invention has a number of advantageous features.

Firstly, the heating pad is made from carbon (in the form of functionalised graphene particles) and polymer, which are relatively low cost compared to known heating pads based on, for example, metals such as silver. Therefore, the heatable garment, fabric and bedding are cost effective and a simple way of heating the body.

Secondly, the functionalised graphene particles display high conductivity and high dispersibility in the polymer matrix material, meaning that they can form a suitably conductive heating pad at relatively low loading levels in the polymer matrix material. These low loading levels mean that the mechanical properties of the heating pad can be dominated by the relatively more flexible polymer matrix material, instead of the less flexible graphene particles. The small size of the graphene particles also lessens the impact of the particles on the mechanical properties of the heating pad compared to relatively larger particles.

Thirdly, adhering the heating pad to the garment body helps the heating pad to flex and adapt to deformation of the garment, whilst maintaining the heating pad in close proximity with the wearer of the garment. This arrangement can be more effective than, for example, garments in which a heating pad is held within a fabric pocket, where deformation of the garment does not so easily translate into deformation of the heating pad, and hence where deformation of the garment can result in the heating pad not conforming to the wearer of the garment.

Adhering the heating pad to the garment body also allows for a relatively compact construction. For example, the garment body provides structural reinforcement to the heating pad, meaning it can be made relatively thinner than a heating pad which is simply sewn to the garment or held in a pocket or pouch.

Fourthly, construction of the heatable garment is relatively simple. For example, the construction avoids the need to form a conductive fibre into the fabric of the garment itself and avoids the need to form separate pouches or pockets in the garment for incorporation of the heating pad.

Fifthly, the graphene-based heating pad can have a rapid temperature response to applied voltages and good heat stability, even when flexing. For example, the inventors have found that graphene-based heating pads as used in the present invention can settle at an equilibrium temperature after approximately 20 seconds and will cool down within seconds of the voltage being removed. This is most probably due to the graphene nanoparticles' excellent thermal conductivity properties. This allows higher temperatures to be safely applied to an animal with a reduced risk of burning, since sudden temperature increases can be rapidly reduced by decreasing the applied voltage.

Sixthly, the uniformity of the heat distribution of a graphene-based heating pad compared to that of a traditional serpentine wire heater is improved, due to the ability to provide more even/uniform heat to an area. This again allows for a safer and more controlled application of heat for use upon an animal, since it reduces the likelihood of the formation of hot spots.

Furthermore, the power requirements of the heating pad are relatively low, due to the excellent electrical and thermal properties of the graphene particles dispersed in the polymer matrix. This means that the heating pad can be powered using small, lightweight (and hence easily transportable), long-lasting power supplies, thus improving the “wear-ability” and usability of the heated garments. Consequently, the heatable garments can be used for applications ill-suited to previous heatable garments. This is especially true of high-performance sports applications, where benefits provided by heating systems can readily be outweighed by drawbacks associated with the size and weight of the systems.

The present invention also provides some advantages compared to the exemplary graphene-based materials disclosed in e.g. WO 2017/129663 A1. Without wishing to be bound by any theory, the inventors believe that the combination of low oxygen content and high nitrogen content provides both good dispersibility of graphene particles in the polymer matrix material and increased conductivity of the graphene particles within the heating pad. This is unexpected, for example, because oxygen functionality improves dispersibility of graphene particles in many polymer matrix materials. Therefore, it was expected that removal of oxygen content would lead to lower dispersibility in the polymer matrix material and consequently heating pads comprising such might have comparatively low conductivity (or require undesirably high graphene particle loadings). However, the inventors have discovered that the combination of low oxygen content with nitrogen functionalisation leads to heating pads with excellent dispersibility and—due to low oxygen content-higher conductivity. Importantly, the inventors find that their method of nitrogen functionalisation (plasma-based process) does not significantly disrupt the sp² carbon content of the graphene particles. Without being bound by any theory, it is believed that this is different from graphene oxide, where planar sp² carbon can be lost in favour of sp³ carbon bonds due to the harsh treatment processes used to produce graphene oxide. Therefore, the improved conductivity seen by removal of oxygen is retained following nitrogen functionalisation. Therefore, the benefits discussed above are enhanced in the pads, garments, bedding and fabrics of the present invention.

The present materials are prepared using environmentally friendly technology and do not use harsh or toxic chemicals.

The garment of the second aspect is for use by an animal. The animal may be, for example, a human or other mammal (e.g. dog or horse). The heatable garment is preferably heatable to body temperature, or just above body temperature, for the relevant animal. For example, when the heatable garment is for use by mammals, the garment is preferably heatable to temperatures in the range of 35° C. to 45° C. (˜37° C. in the case of garments for human use).

Particularly useful embodiments of the present invention have been designed for use by humans, particularly humans participating in sporting activities.

### Heating Pad

The heating pad of the present invention comprises functionalised graphene particles dispersed in a polymer matrix material. The functionalised graphene particles have low oxygen content (less than 4 at %) and are nitrogen functionalised so as to have a nitrogen content of at least 3 at %.

The heating pad produces heat through resistive heating upon application of an electrical current. The amount of heat generated is determined by the relationship: power=V²/R. Accordingly, by reducing resistance in the heating pad, the present invention increases the power generated for a particular current/applied voltage.

To achieve safe and useful temperatures from suitable power supplies, the heating pad typically has a resistance of 100 Ω or less, 75Ω or less, 50 Ω or less, 40 Ω or less, 30 Ω or less, 20 Ω or less, 15 Ω or less, 12 Ω or less, 10 Ω or less, or 8 Ω or less. The resistance may be measured with a two point probe, optionally corner to corner. Advantageously, smaller resistances require lower voltages to achieve a desired power level, and hence can run off a low voltage battery supply, which can improve safety and reduce the weight and bulk. This is particularly important when considering a heatable garment.

The sheet resistance normalised to 25 μm may be, for example, 100 Ω/square or less, 75 Ω/square or less, 50 Ω/square or less, 40 Ω/square or less, 30 Ω/square or less, 20 Ω/square or less, 15 Ω/square or less, 12 Ω/square or less, 10 Ω/square or less, or 8 Ω/square or less. The sheet resistance may be measured with a four point probe.

The heating pad of or used in the present invention may be a single layer of conductive material, or be formed from multiple stacked layers (e.g. 2, 3, 4 or 5) of conductive material. Coating/printing multiple stacked layers to form the heating pad can result in a more uniform thickness (and hence more uniform heating) than coating/printing a single layer of the same overall thickness.

The average (mean) thickness of the heating pad (i.e. mean distance between the bottom surface of the heating pad and the top surface of the heating pad) may be, for example, less than 300 μm, less than 200 μm, less than 150 μm, preferably less than 100 μm or less than 75 μm. The lower limit for the average thickness of the heating pad may be, for example 1 μm, 3 μm, 5 μm or 10 μm. Preferably, the average thickness is 1 to 100 μm, more preferably 1 to 75 μm. In instances where the heating pad is formed from multiple layers, each layer may have a maximum average thickness of, for example, 50 μm, 25 μm, 15 μm, 10 μm or 5 μm. The minimum average thickness may be, for example, 0.5 μm, 1 μm, 3 μm or 5 μm. Preferably, the average thickness of each layer is 1 to 20 μm, such as 1 to 15 μm or 10 to 20 μm. Advantageously, such thicknesses allow the heating pad to be easily deformable/reformable and provide sufficient resistance for the required heating whilst allowing a relatively thin device to be produced.

Preferably, the heating pad is a heatable coating bonded (directly or indirectly) to the garment body. A heating pad in the form of a heatable coating can be made relatively thinner than a heating pad in the form of a moulded article which is subsequently adhered to the garment. Advantageously, decreasing the thickness of the heating pad helps to improve the pad's flexibility and stretchability. When the heatable coating is bonded directly to the garment body, this results in a particularly compact construction.

Most preferably, the heating pad is or comprises one or more layers of an electrically conductive ink comprising the graphene particles in a polymer matrix material which has been applied to a portion of the garment body. When the conductive ink is applied directly to the garment body, the ink, when cured, adheres directly to the garment surface without the need for a separate adhesive. Advantageously, garments in which a conductive ink is applied to the garment body can be made relatively compact, and hence can have minimal impact on the mechanical properties of the garment. Furthermore, the heating pad can be formed by applying the ink to the area of interest, which is relatively straightforward compared to having to manufacture the heating pad as a separate part in the desired shape and size, before applying to the garment.

The heating pad may take the form of a line, sheet, or patch extending across the surface of the garment body. The surface area of the sheet may be, for example, 0.5 cm² or more, 1 cm² or more, 2 cm² or more, 3 cm² or more, 5 cm² or more, 10 cm² or more, 15 cm² or more, or 20 cm² or more.

The heating pad may be on the outside/exterior of the garment. Advantageously, in such embodiments, the garment body can electrically insulate the user from the heating pad, whilst still permitting heat transfer through the garment body.

Alternatively, the heating pad may be on the inside/interior of the garment, such that it is facing the wearer's body in use. Advantageously, this can allow the heating pad to be brought into closer proximity to the wearer than might be possible with a heating pad on the exterior of the garment body.

A further alternative is for the heating pad to be adhered within the garment body.

The heatable garment may comprise more than one of the heating pads described above, such as 2, 3, 4, 5, 6, 7, 8, 9 or 10 heating pads. For example, the heatable garment may have multiple heating pads targeting different muscle groups of the body, or different blood vessels of the body.

### Graphene Particles

The heating pad used in the present invention comprises or consists essentially of functionalised graphene particles (referred to as “graphene particles” herein for brevity) dispersed in a polymer matrix material. The graphene particles are conductive and allow heating of the heating pad through resistive (Joule) heating.

The graphene particles may be randomly dispersed in the polymer matrix material. Providing carbon in this form instead of, for example, in the form of woven carbon microfibre sheets encased within a polymer matrix material, simplifies manufacture and reduces expense. Furthermore, the conductivity of graphene particles (which is higher than, for example carbon black and graphite) means that a conductive heating pad can be formed with relatively low loadings. In addition, using carbon particles in this form allows the heating pad to be applied using coating (e.g. printing) techniques, which simplifies manufacture compared to use of woven carbon microfibre, particularly when used to form complex shapes on the garment body.

Suitably, the graphene particles have a high aspect ratio. Advantageously, graphene particles having a high aspect ratio can form conductive paths at relatively low loading levels, helping to improve the flexibility of the heating pad.

The graphene particles (which can be referred to as “graphene-material particles”, or “graphene-based particles”) may take the form of monolayer graphene (i.e. a single layer of carbon) or multilayer graphene (i.e. particles consisting of multiple stacked graphene layers). Multilayer graphene particles may have, for example, an average (mean) of 2 to 100 graphene layers per particle. When the graphene particles have 2 to 5 graphene layers per particle, they can be referred to as “few-layer graphene”.

Advantageously, these forms of carbon nanoparticles provide extremely high aspect ratio conductive particles. This high aspect ratio allows the formation of conductive paths at relatively low loading levels, decreasing the volume of the heating pad occupied by the carbon nanoparticles and thus increasing the flexibility/stretchability of the heating pad.

The graphene particles may take the form of plates/flakes/sheets/ribbons of multilayer graphene material, referred to herein as “graphene nanoplatelets” (the “nano” prefix indicating thinness, instead of the lateral dimensions).

The graphene nanoplatelets may have a platelet thickness less than 100 nm and a major dimension (length or width) perpendicular to the thickness. The platelet thickness is preferably less than 70 nm, preferably less than 50 nm, preferably less than 30 nm, preferably less than 20 nm, preferably less than 10 nm, preferably less than 5 nm. The major dimension is preferably at least 10 times, more preferably at least 100 times, more preferably at least 1,000 times, more preferably at least 10,000 times the thickness. The length may be at least 1 times, at least 2 times, at least 3 times, at least 5 times or at least 10 times the width.

The loading of graphene particles in the polymer matrix material may be, for example, 0.25 wt. % or more, 0.5 wt. % or more, 1 wt. % or more, 2 wt. % or more, 5 wt. % or more, 10 wt. % or more, 15 wt. % or more, 20 wt. % or more, 30 wt. % or more, 40 wt. % or more, 50 wt. % or more or 60 wt. % or more of the total weight of the heating pad. The upper limit for the loading of graphene particles in the polymer matrix material may be, for example, 1 wt. %, 2 wt. %, 5 wt. %, 10 wt. %, 15 wt. %, 20 wt. %, 30 wt. %, 40 wt. %, 50 wt. %, or 60 wt. % or 70 wt. %. Preferably, the upper limit for the loading of graphene particles in the polymer matrix may be 20 wt. %, 25 wt. % or 30 wt. %. If the loading of graphene particles is too low then the resistance of the heating pad will be high, necessitating greater voltages to achieve a desired temperature. If the loading is too high, then this can adversely affect the mechanical properties of the heating pad (in particular, flexibility and stretchability), and hence the mechanical properties of the heatable fabric. For these reasons, it is preferable for the loadings of the graphene particles to be in the range of, for example, 0.25 to 30 wt. %, 1 to 25 wt. %, 5 to 50 wt. %, 10 to 40 wt. %, 20 to 40 wt. %, or more preferably 5 to 20 wt. %. Optionally, the conductive layer may comprise additional carbon fillers such as graphite, carbon black, furnace black, carbon nanotubes, etc. Preferably the optional additional carbon filler is graphite and/or carbon black. Preferably the additional carbon filler loadings are 5 to 10 wt. % of the total weight of the conductive layer of the heating panel. The upper limit for the total carbon content of the conductive layer including the graphene and carbon filler may be 50 wt. % or less, 40 wt. % or less, or preferably 30 wt. % or less

When the graphene particles are functionalised per the invention, uniform dispersion throughout the polymer matrix material can be achieved. This is important, since aggregates (clumps) of material may decrease the uniformity of heating of the fabric in use and such particles have a powerful tendency to agglomerate and are difficult to disperse in solvents and polymer materials.

In the present invention, the graphene particles are functionalised graphene particles, e.g. functionalised graphene or functionalised graphene nanoplatelets. That is, the graphene particles incorporate functional groups which improve the affinity of the nanoparticles for the solvents and/or polymer matrix material used to form the heating pad, thus allowing a more uniform distribution of particles to be achieved. Specifically, the graphene particles have a low oxygen content (less than 4 at %) and are nitrogen functionalised. The nitrogen functionality can be any suitable form such as amine, pyrrolic, pyridinic etc.

If desired, other functionality could be incorporated. For example, the graphene particles may also be halogen functionalised. Other functionalities incorporating oxygen (such as hydroxy functionalisation) are considered unsuitable for the present invention.

Preferably, the functionalised graphene particles are plasma-functionalised graphene particles (i.e. particles which have been functionalised using a plasma-based process). Advantageously, plasma-functionalised graphene particles can display high levels of functionalisation, and uniform functionalisation.

In particular, the inventors have found that when graphene particles are prepared using agitation in low-pressure plasma, such as described in WO2010/142953 and WO2012/076853 and especially preferably WO2022/058542, WO2022/058546 or WO2022/058218, they are readily obtained in a format enabling dispersion in solvents and subsequently in polymer matrices, or directly in polymer melts, at good uniformity and at levels more than adequate for the purposes set out above. This is in contrast to conventional processes for separating and functionalising graphene particles, which are extreme and difficult to control, as well as damaging to the particles themselves.

Specifically, the starting carbon material—especially graphitic carbon bodies—is subjected to a particle treatment method for disaggregating, de-agglomerating, exfoliating, cleaning or functionalising particles, in which the particles for treatment are subject to plasma treatment and agitation in a treatment chamber. Preferably the treatment chamber is a rotating container or drum. Preferably the treatment chamber contains or comprises multiple electrically-conductive solid contact bodies or contact formations, the particles being agitated with said contact bodies or contact formations and in contact with plasma in the treatment chamber.

Preferably the contact bodies are moveable in the treatment chamber. The treatment chamber may be a drum, preferably a rotatable drum, in which a plurality of the contact bodies is tumbled or agitated with the particles to be treated. The wall of the treatment vessel can be conductive and form a counter-electrode to an electrode that extends into an interior space of the treatment chamber.

During the treatment, desirably glow plasma forms on the surfaces of the contact bodies or contact formations.

Suitable contact bodies are metal balls or metal-coated balls. The contact bodies or contact formations may be shaped to have a diameter, and the diameter is desirably at least 1 mm and not more than 60 mm.

The pressure in the treatment vessel is usually less than 500 Pa. Desirably during the treatment, gas is fed to the treatment chamber and gas is removed from the treatment chamber through a filter. That is to say, it is fed through to maintain chemical composition if necessary and/or to avoid build-up of contamination.

The treated material, that is, the particles or disaggregated, deagglomerated or exfoliated components thereof resulting from the treatment, may be chemically functionalised by components of the plasma-forming gas, forming e.g. amine functionalities on their surfaces. Plasma-forming gas in the treatment chamber may be or comprise e.g. nitrogen, ammonia, amino-bearing organic compound, halogen such as fluorine, halohydrocarbon such as CF₄, and noble gas. Most preferred is ammonia. Oxygen-functionalised materials, plasma-processed in oxygen, or oxygen-containing gas, are advantageously avoided for preparing materials according to the present invention.

Any other treatment conditions disclosed in the above-mentioned WO2010/142953 and WO2012/076853 and especially preferably WO2022/058542, WO2022/058546 or WO2022/058218 may be used, additionally or alternatively. Or, other means of functionalising and/or disaggregating carbon particles may be used for the present processes and materials, although we strongly prefer plasma-treated materials.

For the present purposes the degree of chemical functionalisation of the graphene particles is selected for effective compatibility at the intended loadings with the selected polymer matrix material. A typical upper limit is 21 at % nitrogen, because higher levels indicate the presence of impurities or loss of sp² carbon content (and therefore sub-optimal conductivity). A suitable lower limit is at least 3 at % of nitrogen, at least 5 at % of nitrogen, at least 10 at % of nitrogen, or at least 15 at % of nitrogen. Accordingly, appropriate ranges of nitrogen-functionalisation include nitrogen at 3-20 at %, such as 5-20 at % or 10-20 at %, preferably 5-19 at %, more preferably 10-18 at %. Other end-points can be combined appropriately.

As mentioned elsewhere, XPS is used to determine the extent (degree) of N functionalisation i.e. nitrogen content.

XPS uses monochromatic x-rays to eject core electrons from surface atoms in a sample. These core electrons have specific and well-documented binding energies, which are affected by an atom's chemical environment. As the electrons are ejected from the sample, they are counted, and the kinetic energy measured. This results in peaks in the output spectrum. As each electron is from a single atom, XPS is quantitative. The peak areas can be fitted to give distributions of area within the peaks at different binding energies. Thus, XPS is qualitative as well as quantitative, giving highly detailed and accurate chemical information of a material's surface.

Any suitable XPS spectrometer can be used to determine nitrogen and oxygen content. Such methods are well within the purview of the skilled person. The inventors use a ThermoFisher K-α X-ray photoelectron Spectrometer System using an aluminium X-ray source. The sample area is usually in the shape of an ellipse having a maximum width of 400 μm and a measuring depth of up to 9 nm.

Other methods of characterising the oxygen and nitrogen contents of the graphene particles may be used. WO2015/150830 describes a method of characterising surface chemistry by monitoring changes in dispersion. Other measurements that can be made include zeta potentials, which correlate with the degree of nitrogen functionalisation but do not show precisely the amount of nitrogen present in the sample. The inventors find that nitrogen-functionalised graphene particles having less than 4 at % of oxygen and at least 3 at % of nitrogen show a zeta potential at pH 3 of more than 3 mV, such as at least 10 mV, at least 25 mV, at least 35 mV, preferably more than 40 mV. See also FIG. 3.

The skilled person will be aware of suitable methods for measuring zeta potentials. An exemplary method involves dispersing 10 mg of functionalised graphene particles in 20 mL of pH 3 solution, adding aliquots of the dispersion in a cell which is then placed in a Malvern Zetasizer Nano-Z instrument. During the measurement, a potential difference is applied at either end of the cell and the voltage is measured and recorded. The results may then be cross-referenced against a standard.

Similar to the zeta potential, measurement of the acid number can be used to confirm nitrogen functionalisation of the particles. The skilled person will be aware of suitable methods for measuring the acid number. An exemplary method involves measurement with a Mettler Toledo InMotion Pro titrator and autosampler, where the sample is neutralised with potassium hydroxide and titrated against e.g. HCl (hydrogen chloride) giving the equivalence points of any acids present. In particular, the acid number for unfunctionalized graphene particles is typically a positive value, while nitrogen functionalisation leads to a negative acid number such as −0.10 or −0.15 mg·KOH/g. See also FIG. 4.

The graphene particles of the present invention have an oxygen content of less than 4 at %. Lower oxygen contents are believed to be even more advantageous from the perspective of improved conductivity, so preferred are graphene particles having an oxygen content of less than 2 at %, preferably less than 1.5 at %, more preferably less than 1 at % such as less than 0.5 at %.

Although it is possible to buy graphene particles having low oxygen content, commercially available graphene particles typically contain around 5 at % of oxygen even in the absence of treatments to specifically introduce oxygen. Such oxygen contents are too high for the present invention. Furthermore, it may be desirable to reduce the oxygen content of the graphene particles starting material, to further enhance the benefits of the present invention. This can be achieved by any suitable process. In such process, it is necessary to remove moisture because the graphene particles can become oxygen functionalised in the presence of moisture.

An exemplary process that can be used to reduce oxygen content is annealing. Such may take place in argon, to avoid the presence of moisture or oxygen from the air.

As the skilled person will be aware, annealing is a process of heating to a predetermined temperature for a predetermined length of time, followed by slow cooling. In the present case, annealing may be used to achieve reduced oxygen content of the graphene particles. The skilled person can determine suitable conditions, but heating to a temperature of e.g. 600-1000° C. such as 850° C. for 1-5 hours followed by cooling for 1-5 hours might be suitable. Such conditions have been found to have only a small effect on the sp² carbon content as determined by XPS.

Preferably, the sp² carbon content of the functionalised graphene particles is at least 65 at %, such as at least 70 at % or more.

The inventors believe that annealing before nitrogen treatment may remove oxygen and restore sp² carbon, while heating during and after the treatment removes volatiles including any potential NOx.

It is generally preferable to nitrogen-functionalize graphene particles which already have the required low oxygen content, to maximise the available carbon for functionalising. The annealing can be carried out before, partway through (such as midway through), or after the plasma functionalisation and can involve the use of a furnace or the use of a heated reactor barrel as in patent application number WO2022/058542.

For example, annealing can be carried out first to ‘clean’ a sample by removing oxygen, moisture and other impurities. This is carried out under argon (or other inert gas, such as nitrogen, particularly if in an oven or furnace). That process is followed by nitrogen functionalisation, followed by annealing again, if wanted.

Other forms of conductive particle filler may be used in the heating pad alongside the graphene particles. For example, the heating pad may further comprise carbon nanotubes (single-walled or multi-walled), carbon black, or metal particles (e.g. silver particles).

### Polymer Matrix Material

Suitably, the polymer matrix material of the heating pad is an elastic material. The particular choice of elastic material is not particularly limited, provided that it is sufficiently elastically deformable at normal operating conditions of the garment and holds the graphene particles in position (so that the distribution of graphene particles does not change over time).

Suitable materials include, for example, vinyl polymers (including polymers or copolymers of vinyl chloride, vinyl acetate and vinyl alcohol), polyester polymers, phenoxy polymers, epoxy polymers, acrylic polymers, polyamide polymers, polypropylenes, polyethylenes, silicones, elastomers such as natural and synthetic rubbers including styrene-butadiene copolymer, polychloroprene (neoprene), nitrile rubber, butyl rubber, polysulfide rubber, cis-1,4-polyisoprene, ethylene-propylene terpolymers (EPDM rubber), and polyurethane (polyurethane rubber). The polymer matrix material may be, for example, a copolymer of vinyl chloride, vinyl acetate and/or vinyl alcohol.

The polymer matrix material may be a thermoplastic material. Alternatively, the polymer matrix material may be a thermosetting material.

The polymer matrix material may comprise or be polyurethane, for example a thermoplastic polyurethane elastomer. Advantageously, the present inventors have found that using polyurethane (especially thermoplastic polyurethane elastomer) as the polymer matrix material produces heating pads with good mechanical properties, in particular a good level of flexibility. This helps the heating pad to conform to the body of the garment's wearer during use.

### Garment Body

The portion of the garment body to which the heating pad of the invention can be adhered is made from a clothing material, preferably a fabric. The fabric may be a woven, crocheted, knitted or non-woven fabric formed from fibres/yarns. Preferably, the fabric is a woven fabric.

The portion of the garment body to which the heating pad is adhered may be formed from natural or synthetic material. For example, the said portion of the garment body may comprise of consist of natural fibres (e.g. cotton, wool, flax, silk), or a natural material such as leather. Additionally or alternatively, the said portion of the garment body may comprise or consist of synthetic fibres (polyester fibres, polyester-polyurethane copolymers such as Lycra®, acrylic fibres, and polyamide fibres such as nylon), or a non-foam or (more preferably) foamed polymer such as neoprene.

Preferably, the garment body is flexible (i.e. capable of bending and returning to its original shape without breaking). Optionally, the garment body is stretchable (i.e. capable of being made longer or wider without tearing or breaking). Garments formed from flexible and/or stretchable materials are able to conform to a user's body as they move.

In some embodiments, the garment body is permeable to the material used to form the heating pad (e.g. conductive ink) such that said material permeates/infiltrates the garment body during formation. For example, the garment body may be made from a woven or non-woven fabric through which the heating pad permeates during construction. This can ensure a good bond between the heating pad and garment body.

When the garment body is made from fibres/yarns, the fibres/yarns may be permeable to the material used to form the heating pad (e.g. conductive ink) such that said material permeates/infiltrates the fibres/yarns during formation. Again, this ensures a good bond between the heating pad and garment body.

The heating pad may be adhered to a detachable part of the garment body i.e., a part of the garment body which can be detached from other parts of the garment body. In such instances, it is preferred that the detachable part of the garment body is reversibly detachable. For example, the heating pad may be provided on a detachable strap or pad. The detachable part of the garment body may be held in place by a reusable fastener, such as a hook-and-loop fastener (e.g. Velcro®), a button, a press stud, a buckle, or zip. Advantageously, such an arrangement can allow the heating pad to be replaced (e.g. when the power supply is low, or there is a fault with the heating pad) or removed (e.g. for cleaning). Alternatively, the heating pad may be adhered to a non-detachable part of the garment body.

### Covering Layer

Preferably, the heatable garment comprises an electrically-insulating covering layer, overlaying (e.g. encapsulating) and bonded to the heating pad. Advantageously, the electrically-insulating covering layer helps to improve the mechanical properties of the heatable garment. In particular, it reduces the occurrence of cracking of the heating pad upon deformation of the garment. Furthermore, the electrically-insulating covering layer helps to electrically insulate the user from the heating pad, and prevents short-circuits forming when different regions of the heating pad are brought into contact (which might otherwise lead to non-uniform heating). In addition, the electrically-insulating covering layer can protect the heating pad from damage, e.g. by water during a wash process, and can allow higher temperatures to be achieved.

The electrically-insulating covering layer may be adhered to the heating pad. Most preferably, the electrically-insulating covering layer is coated (e.g. printed) on the heating pad.

Preferably, the electrically-insulating covering layer is formed from an elastic material, e.g. an elastic polymer. This allows the covering layer to mechanically adapt as the wearer of the garment moves, increasing comfort for the wearer.

Suitable materials include, for example, vinyl polymers (including polymers or copolymers of vinyl chloride, vinyl acetate and vinyl alcohol), polyester polymers, phenoxy polymers, epoxy polymers, acrylic polymers, polyamide polymers, polypropylenes, polyethylenes, silicones, elastomers such as natural and synthetic rubbers including styrene-butadiene copolymer, polychloroprene (neoprene), nitrile rubber, butyl rubber, polysulfide rubber, cis-1,4-polyisoprene, ethylene-propylene terpolymers (EPDM rubber), and polyurethane (polyurethane rubber). The material of the covering layer may be, for example, a copolymer of vinyl chloride, vinyl acetate and/or vinyl alcohol. In preferred embodiments, the coating material comprises or is the same material as the polymer matrix material.

Preferably, the electrically-insulating covering layer is formed from a coatable material, such as a polymer ink. For example, the layer may be formed by polymer ink comprising a suspension of polymer particles in a liquid plasticizer (for example “Plastisol®”—a suspension of PVC particles in a liquid plasticizer), which can be printed and cured, for example, by heating.

The electrically-insulating covering layer may comprise or be formed from polyurethane, for example a thermoplastic polyurethane elastomer. Advantageously, the present inventors have found that using polyurethane (especially thermoplastic polyurethane elastomer) as the electrically-insulating covering layer produces heatable garments with good mechanical properties, in particular a good level of flexibility. This helps the heatable garment to conform to the body of the garment's wearer during use.

The electrically-insulating covering layer may be, or comprise, silicone rubber, since this can provide excellent flexibility and deformability without cracking.

Alternatively, or in addition, the heatable garment may include an electrically insulating covering layer bonded to the garment body underneath the heating pad (i.e. on the opposite side of the garment body to the side on which the heating pad is provided). For example, the heatable garment may have electrically-insulating covering layers bonded to both sides of the garment body in the portion of the garment body provided with the heating pad, such that the heating pad and garment body are sandwiched between electrically-insulating layers. In such embodiments, the covering layers may form a watertight seal around the heating pad.

In a particularly preferred embodiment, the heatable garment comprises an electrically insulating covering layer bonded to the garment body underneath the heating pad and an electrically-insulating covering layer, overlaying (e.g. encapsulating) and bonded to the heating pad. That is, the heatable garment has a first covering layer bonded directly to the garment, a second layer comprising the functionalised graphene particles dispersed in polymer matrix material (e.g. conductive ink) bonded (directly or indirectly) to the first layer, and a third covering layer bonded (directly or indirectly) to the second layer. In such preferred embodiment, the first and third layers preferably comprise a material which is the polymer matrix material of the second layer. In some such embodiments, the second layer is bonded directly to the first layer and directly bonded to the third (covering) layer.

### Intermediate Layer

Optionally, the heatable garment comprises an intermediate layer between the garment body and the heating pad. In such instances, the heating pad is indirectly adhered to the garment body, with the heating pad adhered to the intermediate layer which is itself adhered to the garment body. Advantageously, the intermediate layer may provide a uniform surface for adherence of the heating pad to the garment body. In addition, the intermediate layer can reduce the mechanical stresses on the heating pad as the garment is deformed, especially for fabric materials where fibres can move relative to one another.

The intermediate layer may be coated (for example, printed) on the garment body directly. For example, the heatable garment may have an intermediate layer coated on the garment body, with the heating pad coated directly on the intermediate layer. Alternatively, the intermediate layer may be a pre-formed sheet of material which is adhered to the heatable garment, for example, through the application of heat (e.g. from an iron).

The intermediate layer may be an electrically-insulating intermediate layer.

Preferably, the intermediate layer is formed from an elastic material, e.g. an elastic polymer. Suitable materials include those mentioned above for the covering layer. For example, the intermediate layer may be, or comprise, silicone rubber, since this can provide excellent flexibility and deformability without cracking. A further preferred material for the intermediate layer is polyurethane, for example a thermoplastic polyurethane elastomer. Advantageously, the present inventors have found that incorporating an intermediate layer formed from polyurethane (especially thermoplastic polyurethane elastomer) leads to heatable garments with good mechanical properties, in particular a good level of flexibility. This helps the heatable garment to conform to the body of the garment's wearer during use.

In embodiments comprising both an electrically-insulating covering layer and an intermediate layer, both of said layers may be made of the same material, e.g. silicone rubber or, preferably, polyurethane. In instances where both layers are formed from polyurethane (e.g. thermoplastic polyurethane), the heatable garment can have particularly good mechanical properties (in particular, flexibility and conformability).

In embodiments comprising both an electrically-insulating covering layer and an intermediate layer, the electrically-insulating covering layer and intermediate layer may encapsulate the heating pad. In such situations, the electrically-insulating covering layer and intermediate layer may form a waterproof seal around the heating pad.

The intermediate layer may be porous/permeable. This can allow water to be taken up by the intermediate layer, which can help to draw moisture (e.g. sweat) away from the user, e.g. by “wicking”. Advantageously, allowing liquid, such as sweat, to enter the intermediate layer can help to improve the thermal conductivity of the intermediate layer.

In some embodiments, the heating pad is provided as an “iron-on” product. In such cases, the heating pad comprises a layer which is capable of adhering to a garment body by application of heat (provided by an iron, for example), and is typically plastic. This layer is separate from the functionalised graphene particles dispersed in the polymer matrix. In some embodiments, another overlying layer is provided to avoid direct contact between the iron and the functionalised graphene particles.

### Heat-Reflective Layer

Optionally, the garment may include a heat-reflective layer to direct heat generated by the heating pad towards the body. For example, the garment may have a metal foil (e.g. aluminium foil) on the exterior of the garment to reflect heat from the heating pad towards the body.

### Electrical Connectors

The heatable garment may include electrical connectors on (e.g. abutting/overlaying) the heating pad to facilitate connection of an electrical power supply. For example, the heatable garment may include one or more metal (e.g. silver) regions on the heating pad to facilitate supply of electricity to the heating pad. Advantageously, these electrical connectors can simplify supply of power to the heating pad and can reduce the resistance of the heating pad.

The one or more electrical connectors may take the form of points, or lines/tracks, optionally formed into a pattern. For example, the electrical connectors may take the form of spaced lines.

### Power Supply

The heatable garment of the present invention is connectable to an electrical power supply. The heatable garment may include the electrical power supply, or it may be supplied without the electrical power supply installed.

The electrical power supply may be a battery (for example, a button cell battery), or a supercapacitor.

Preferably, the heatable garment is heatable to body temperature of the relevant animal upon application of power from the power supply. For mammals, this means that the heater is heatable to temperatures in the range of 35° C. to 45° C. (˜37° C. in the case of fabrics for human use). For the avoidance of doubt, the temperatures above refer to the temperature of the heatable garment itself (as opposed to the temperature at a distance from the heatable garment), as measured, for example, via a thermal imaging camera.

The maximum temperature achievable by the heater upon supply of power from the power supply may be 200% or less of normal body temperature, 175% or less of normal body temperature, 150% or less of normal body temperature, 125% or less of normal body temperature, or 110% or less of normal body temperature (based on calculations using body temperature expressed in ° C.). For example, the maximum temperature achievable by the heater upon supply of power from the power supply may be 70° C. or less, 60° C. or less, 55° C. or less, 50° C. or less, 45° C. or less, or 40° C. or less. These values are based on normal operation of the device (as opposed to temperatures achieved in the event that the device malfunctions). Advantageously, designing the heatable garment to have a maximum temperature in the ranges above limits or prevents the possibility of the heatable garment damaging a wearer of the garment.

Most preferably, the heatable garment is heatable to a temperature just below (for example, <2° C. below, such as 1-2° C. below) the temperature at which thermal burning of skin occurs. For example, in humans, it is preferable that the heatable garment is heatable to temperatures of 42 to 43° C. (just below the thermal burn temperature of 44° C. for human skin). The heatable garment may be configured such that the maximum temperature to which the garment can be heated is just below the temperature at which thermal burning of skin occurs, for example, 0.5 to 5° C. below, preferably 1 to 3° C. below, more preferably 1 to 2° C. below the thermal burning temperature.

In embodiments comprising an electrically-insulating covering layer, said layer may cover the power supply. In embodiments in which the heating pad is encapsulated by electrically-insulating covering layers and/or an intermediate layer, said layers may also encapsulate the power supply. In such situations, the electrically-insulating covering layers and/or intermediate layer may form a waterproof seal around the heating pad and power supply. In such embodiments, the power supply may be rechargeable via electrical induction.

### Control

The heatable garment may comprise a temperature control system, to control the temperature of the heating pad. For example, the control system may allow the amount of power supplied to the heating pad to be adjusted, e.g. in a stepped or continuous manner. This may control switching on and off of the heating pad and/or switching between lower and high-power settings.

In embodiments in which the heatable garment comprises multiple heating pads, the control system may allow independent control over the temperature of each, or a subset of, the heating pads. For example, in a heatable garment comprising multiple heating pads which target different muscle groups, the control system may allow the temperature of heating pads to be independently adjusted according to the muscle group.

The control system may include an interface (such as a button, switch, or dial) for a user to adjust the temperature of the heating pad(s). In addition, or alternatively, the control system may be programmable to adjust the power level according to a pre-determined program. In this way, heating provided by the heatable garment can be customised to a particular individual, or application.

Preferably, the control system is configured so that the temperature of the heating pad cannot exceed a certain threshold (as per the temperature ranges mentioned above). Furthermore, the control system may include a cut-off feature, which reduces or stops power supply when a certain temperature is reached.

The control system may be configured to control the temperature of the heating pad by voltage regulation, a positive temperature coefficient (PTC) thermistor, or by varying the duty cycle of the power supply.

### Hardware/Software

The heatable garment may further comprise software and/or hardware configured to run by an external application (“app”).

“Software” means a set of instructions that when installed on a computer configures that computer with the readiness to perform one or more functions. The terms “computer program,” “application” and “app” are synonymous with the term software herein.

In some embodiments, one or more of the electronic features, settings or characteristics of the heatable garment, such as temperature or battery level, can be viewed, selected, and/or adjusted remotely by a mobile electronic device, such as by way of a wireless communication protocol and/or using a software module or app on a mobile electronic device.

In particular, the software or app may allow a user to monitor the temperature of the heating pad(s) and to adjust the temperature appropriately. The app may also allow the user to adjust the period over which the heatable garment is heated (i.e. the app may act as a timer automatically switching off the heating after a set period of time).

In certain embodiments the heatable garment comprises a controller chip and a temperature sensor configured to measure the temperature of the heating pad(s) and to adjust their temperature. The controller chip may be configured to receive commands from a mobile device. These commands may be transmitted using WiFi or Bluetooth communication.

In particularly advantageous embodiments, the heatable garment is configured to align with a particular schedule e.g. a training schedule. In some embodiments, the heatable garment is configured to allow a subject to input details of a schedule into the app. In some embodiments, the heatable garment is trainable to synchronise with (e.g. precede by a pre-set number of minutes) a schedule. In these embodiments, the heatable garment may be configured to turn on, achieve a desired temperature, and turn off after a defined period, according to the details of the input schedule. Accordingly, also provided herein are methods and uses of the heatable garment according to the present invention as part of a schedule e.g. a training schedule. In such methods and uses, the schedule may be input by the user into an app or be learned by garment software.

### Types of Garment

The heatable garment may be a garment for human use, such as outerwear, underwear, armwear, neckwear, footwear, or headwear.

For example, the garment may be a top (e.g. vest, jersey, short-sleeve t-shirt, long-sleeve t-shirt, jacket), bottoms (e.g. shorts, trousers, hosiery/legwear such as stockings), an item of underwear (e.g. underpants, socks, a bra such as a sports bra or a maternity bra of the kind described in e.g. GB 2111333.7), a one-piece (e.g. swimsuit, leotard, wetsuit), a shoe (e.g. trainers, boots), a strap or belt (e.g. wristband, or strap/belt which can be fixed around a user, e.g. using a fixture such as velcro) an item of headgear (e.g. hat, helmet, or headband), a glove (e.g. cycling gloves, baseball glove), a wetsuit, or a drysuit. The above terminology is based on normal U.K. English usage, and the skilled reader will understand that certain of the above items may be given different names in other English-speaking countries, such as the U.S.

In one embodiment, the garment is a heatable bra, such as a heatable maternity bra, comprising a bra body connecting two cups and wherein at least one cup includes a fabric with a heatable section comprising graphene particles dispersed in a polymer matrix material, the heatable section corresponding with the heating pad of the present invention.

Most preferably, the article is a sports garment.

Suitably, the heating pad is positioned on the garment so as to provide heat to one or more specific areas of the body, such as specific muscles, parts of the vasculature, ligaments, tendons, joints or organs.

The garment may be for human use which covers the wrist of a user when worn (for example, a long-sleeve shirt, long-sleeve t-shirt, long-sleeve jacket; a wristband; or a glove), with at least one heating pad overlaying the wrist. In such garments, the heating pad preferably overlays the anterior portion of the wrist (i.e. the palmar side, or underside), since heat application to this portion of the body is particularly effective at raising the temperature of the hands, due to the thin skin covering the major blood vessels in this region.

For example, the garment may be a glove or wristband having a heating pad overlaying the anterior portion of the wrist, connected to a power supply overlaying the posterior portion of the wrist (i.e. the dorsal side, or back of the wrist). Advantageously, this arrangement means that the power supply causes little irritation to the user whilst allowing heating of blood to the hand via the thin skin overlying the wrist.

The garment may include a pocket for a user's hands, with the heating pad included in the pouch of the pocket.

The garment may be a pair of trousers or shorts, with heating pads targeting specific areas of the leg, such as the thigh, hamstring and/or calf.

The garment may be a top, with heating pads targeting specific areas of the arm and torso, such as the wrist, biceps, triceps, shoulders, back and/or pectoral muscles.

The garment may be a strap/belt/band which can be attached to (e.g. wrapped around) a specific part of the body. Such a garment may be attached to the body via a suitable fastener, such as a hook-and-loop fastener (e.g. Velcro®), a button, a press stud, a buckle, or zip. Advantageously, such a garment can be moved between different parts of the body, making it particularly useful for targeting tight or injured muscles.

The garment may be for use by a non-human applications, such as a horse blanket or dog jacket.

Also disclosed as a further aspect is a heatable bedding comprising a bedding body and a heating pad adhered to at least a portion of the bedding body, wherein the heating pad comprises the functionalised graphene particles dispersed in a polymer matrix material. The graphene particles are nitrogen-functionalised and have an oxygen content of less than 4 at %. The bedding may be, for example, a blanket, a bed sheet, a duvet, a quilt, or a sleeping bag. The heatable bedding may have any of the features discussed above in relation to the first aspect.

### Heatable Fabric

In a still further aspect, the present invention provides a heatable fabric, suitable for forming a heatable garment or heatable bedding of the above aspects, comprising a heating pad adhered to at least a portion of a fabric substrate, wherein the heating pad comprises the functionalised graphene particles dispersed in polymer matrix material.

Preferably, the heating pad is a heatable coating bonded (directly or indirectly) to the fabric substrate. A heating pad in the form of a heatable coating can be made relatively thinner than a heating pad in the form of a molded article which is subsequently adhered to the fabric substrate. Advantageously, decreasing the thickness of the heating pad helps to improve the pad's flexibility and stretchability. Preferably, the heatable coating is bonded directly to the fabric substrate, since this results in a particularly compact construction.

Most preferably, the heating pad is or comprises a layer of an electrically conductive ink comprising graphene particles in a polymer matrix material which has been applied to a portion of the fabric substrate. In this case, when the ink cures it can adhere directly to the fabric substrate without the need for a separate adhesive. Advantageously, fabrics in which a conductive ink is applied to the fabric substrate can be made relatively compact.

Preferably, the heatable fabric comprises an electrically-insulating covering layer, overlaying (e.g. encapsulating) the heating pad. The covering layer may have any of the optional or preferred features of the covering layer mentioned above.

The fabric substrate may be a woven or non-woven fabric. The fibres making such a fabric may be natural or synthetic fibres, such as cotton, wool, flax, silk, polyester, polyester-polyurethane copolymers, acrylic, or polyamide.

The components of the heatable fabric may have any of the optional or preferred features mentioned above in relation to the garment body.

### Manufacturing Methods

In a further aspect, the present invention provides a method of making a heatable garment, comprising:
providing a clothing material; and
depositing one or more layers of a conductive material onto at least a portion of the clothing material to form a heating pad;

wherein the conductive material comprises the functionalised graphene particles dispersed in a polymer matrix material, and wherein the graphene particles have an oxygen content of less than 4 at % and a nitrogen content of at least 3 at %, as described above for the above aspects.

Preferably, the method of making a heatable garment includes preparation of the conductive material using a method comprising:
providing a starting carbon material, comprising graphitic particles;
optionally annealing the starting material to remove oxygen;
subjecting the annealed material to plasma treatment and agitation in a treatment chamber;
chemically functionalising the carbon material by components of the plasma-forming gas, which is preferably ammonia; and
dispersing the functionalised material in a polymer matrix material.

The step of depositing one or more layers of a conductive material over the clothing material preferably involves depositing (coating) a conductive ink on the clothing material. Suitable deposition techniques include, for example, bar coating, screen printing (including rotary screen printing), flexography, rotogravure, inkjet, pad printing, and offset lithography. The conductive ink comprises the functionalised graphene particles dispersed in a solvent and polymer material.

When multiple layers of conductive ink are printed, each layer is preferably dried before a subsequent layer is added. The device may be heated after the application of each conductive ink layer to speed up drying of the ink.

When using a conductive ink, the method preferably involves a step of preparing the ink for printing. This preparation step may involve mixing or homogenising the ink to evenly distribute the graphene particles in the ink's polymer binder. Preferably, the preparation step involves homogenising the ink, since the inventors have found that this ensures a uniform distribution of carbon nanoparticles and can help to break up agglomerates of nanoparticles in the ink. Suitable homogenisation can be achieved using, for example, a three roll-mill or rotor-stator homogeniser.

The method may be carried out on a pre-formed garment, in which case the method involves:
providing a garment body, formed from clothing material; and
depositing one or more layers of a conductive material onto at least a portion of the garment body to form a heating pad.

Alternatively, the garment may be formed after deposition of the conductive material, in which case the method involves:
providing a clothing material;
depositing one or more layers of a conductive material onto at least a portion of the clothing material to form a heating pad;
forming the clothing material into a garment.

When the conductive material is a conductive ink, the clothing material may be permeable to said conductive ink (i.e. penetrates into the clothing material, beyond the surface of the clothing material). This can allow improved bonding between the clothing material and the heating pad.

In such embodiments, the method preferably involves:
providing a clothing material;
depositing a conductive ink (as defined above) onto at least a portion of the clothing material and allowing the ink to at least partially permeate (i.e. soak into) into the clothing material;
removing excess ink from the clothing material;
curing the ink so as to form a first layer of conductive material; and
optionally depositing further layers of conductive material on the first layer of conductive material.

Allowing the conductive ink to partially permeate into the clothing material helps to ensure a good bond between the clothing material and the heating pad.

The time allowed for the ink to permeate into the clothing material (the “ink permeation time”) will vary depending on the type of clothing material and type of conductive ink. The ink permeation time may be, for example, 10 seconds or more, 20 seconds or more, 30 seconds or more, 1 minute or more, 2 minutes or more, 3 minutes or more, 5 minutes or more, 10 minutes or more, 20 minutes or more, or 30 minutes or more.

The ink may permeate to an average (mean) depth of, for example, 0.2 μm or more, 0.5 μm or more, 1 μm or more, 2 μm or more, 3 μm or more, 4 μm or more, 5 μm or more, 8 μm or more, 10 μm or more, 25 μm or more, 50 μm or more or 100 μm or more. The upper limit for the average (mean) permeation depth of the ink may be, for example 100 μm, 250 μm or 500 μm.

The ink may penetrate to an average (mean) depth which corresponds to 5% or more, 10% or more, 25% or more, 40% or more, 50% or more, or 75% or more of the overall thickness of the clothing material (as measured in the region of the ink penetration). For example, the ink may penetrate to an average (mean) depth which corresponds to between 5-75%, 10-50%, or 10-25% of the overall thickness of the clothing material.

When the conductive material is a conductive ink the clothing material is preferably permeable to a solvent which is compatible (e.g. miscible) with the conductive ink, and the clothing material is wetted with said solvent before deposition of the conductive ink.

For example, the method may involve:
providing a clothing material;
depositing a solvent onto at least a portion of the clothing material and allowing the solvent to at least partially permeate the clothing material so as to form a wetted clothing material;
depositing a conductive ink (as defined above) onto the wetted clothing material;
optionally, allowing the ink to at least partially permeate the clothing material;
removing excess ink from the clothing material; and
curing the ink so as to form a first layer of conductive material; and
optionally depositing further layers of conductive material on the first layer of conductive material.

The inventors have found that “wetting” the clothing material with solvent before application of the conductive ink helps to improve permeation/penetration of the conductive ink into the clothing material, and thus improve the bond of the heating pad to the clothing material.

The solvent may be an organic solvent which is miscible with the conductive ink. The solvent may be selected from, for example, alcohols, ethers, and esters. Specific examples include, for example, aldols such as diacetone alcohol (4-hydroxy-4-methylpenta-2-one); dimethyl esters, including mixtures of dimethyl esters (for example, “Estasol™”—a mixture of dimethyl esters of adipic, glutaric and succinic acids); or glycol ethers, such as dipropylene glycol monomethyl ether.

The time allowed for the solvent to permeate into the clothing material (the “solvent permeation time”) will vary depending on the type of clothing material and type of conductive ink. The ink permeation time may be, for example, 10 seconds or more, 20 seconds or more, 30 seconds or more, 1 minute or more, 2 minutes or more, 3 minutes or more, 5 minutes or more, 10 minutes or more, 20 minutes or more, or 30 minutes or more. The solvent may be left for a sufficient time for it to permeate (soak through) the full thickness of the clothing material before application of the conductive ink.

Preferably, the clothing material is held taut during deposition of the conductive material, for example, through using a tenter. In particular, when the clothing material is stretchable, it is preferred that the material is in a stretched (e.g. partially stretched) state during deposition of the conductive material, since this can allow a more uniform deposition of conductive material.

The methods above may also involve depositing a layer of elastomeric material on the clothing material to provide a surface for subsequent deposition of the conductive material. Such a layer corresponds to the “intermediate layer” discussed above and may have any of the features described above in relation to the intermediate layer. This elastomeric material may be coated onto the clothing material. Alternatively, the elastomeric material may be a pre-formed sheet which is adhered to the clothing material, for example, through the application of heat (e.g. an iron).

The methods above may also involve depositing an electrically-insulating coating layer over the heating pad. Such an electrically-insulating coating layer may have any of the features described above in relation to the earlier aspects of the invention. The electrically-insulating coating layer may be coated over the heating pad.

When the heating pad is provided in an “iron-on” form, a method of the invention can comprise providing an iron-on heating pad according to the first aspect, and applying it to a garment by application of heat.

In a further aspect, the invention provides a method of forming a heatable fabric, comprising:
providing a fabric substrate; and
coating (e.g. printing) at least a portion of the fabric substrate with a heating pad, wherein the heating pad comprises graphene particles dispersed in a polymer matrix material.

The method of forming a heatable fabric may have any of the optional and preferred features described above for formation of the heatable garment. For example, the methods may involve the steps of applying (e.g. coating/printing) an electrically-insulating coating layer after formation of the heating pad and/or applying (e.g. coating printing) an intermediate layer on the clothing material before application of the conductive material.

The present invention also provides methods of forming heatable bedding following analogous methods to those described above in relation to heatable garments.

### BRIEF DESCRIPTION OF THE FIGURES

Embodiments of the invention will now be described, by way of example only, with reference to the accompanying drawings in which:

FIG. 1 is an XPS spectrum of a comparative sample of graphene particles having low oxygen content and no nitrogen-functionalisation treatment.

FIG. 2 is an XPS spectrum of a sample of graphene particles according to the invention, having low oxygen content and nitrogen functionalisation.

FIG. 3 is a graph showing zeta potentials of batches of graphene particles having (left) no nitrogen functionalisation and (three rightmost) nitrogen functionalisation.

FIG. 4 is a graph showing acid numbers of batches of graphene particles having (left) no nitrogen functionalisation and (three rightmost) nitrogen functionalisation.

FIG. 5 are graphs showing (upper) the change in O content of graphene particles before and after annealing (compare left with middle) and a commercially-available low-oxygen graphene particles (right), and (lower) the change in sp² carbon content for those same graphene particles as in the upper graph.

FIG. 6 is a photograph showing (left) polymer matrix material with graphene particles not functionalised according to the present invention, and (right) functionalised graphene particles in line with the present invention.

### DETAILED DESCRIPTION

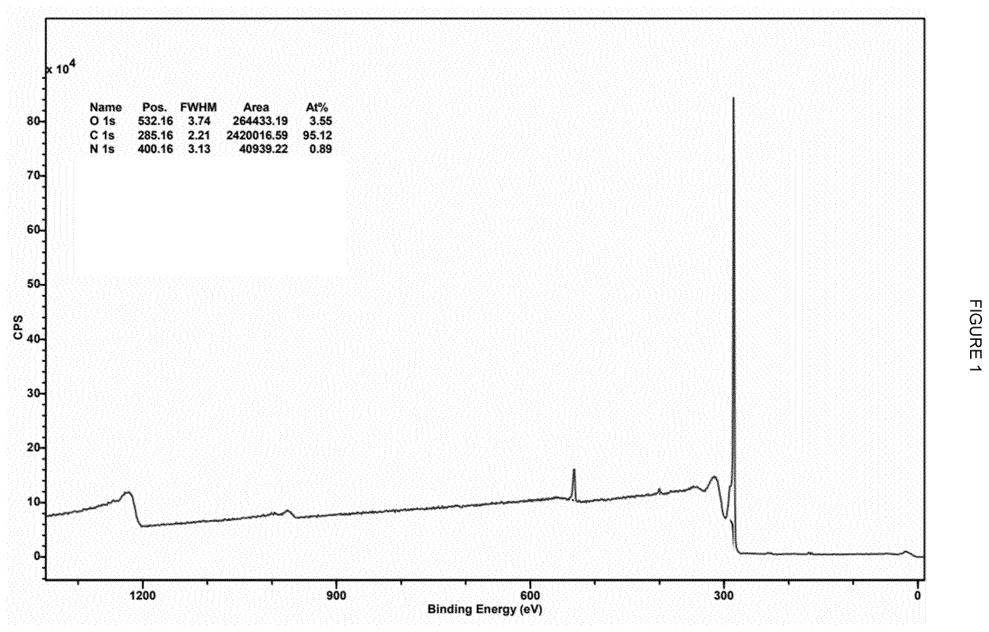

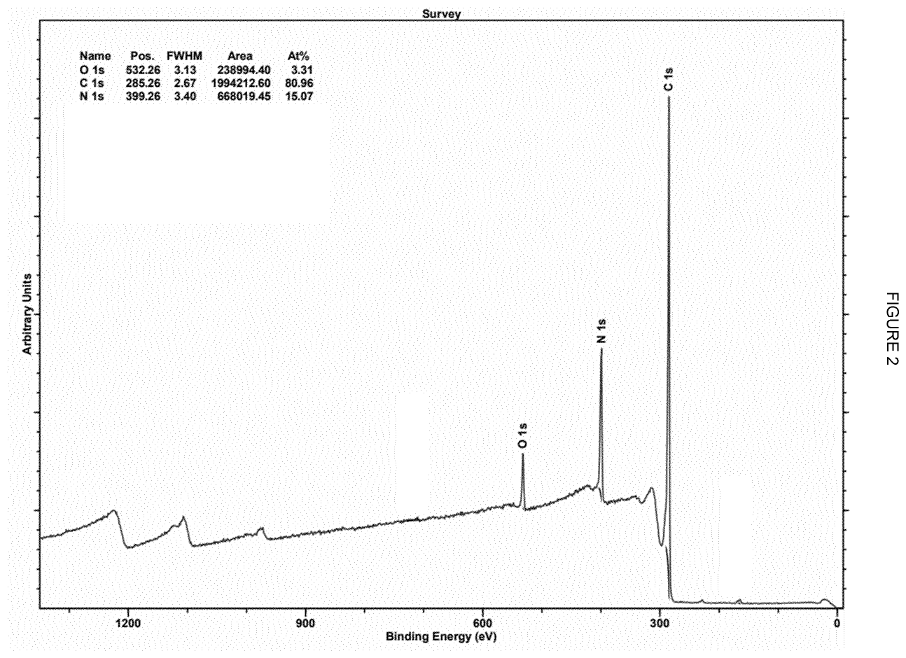

FIGS. 1 and 2 are XPS spectra showing the change that can be observed when nitrogen functionalisation is carried out on a sample of low-oxygen grade graphene particles. In this case, ammonia plasma treatment was carried out and subsequently XPS was used to identify the change in nitrogen (N) at %. It can be seen that the ammonia plasma treatment generates more than 14% increase in chemically bonded surface nitrogen atoms.

The N(1s) XPS peaks can be deconvoluted to give fine detail on nitrogen functionality such as pyrrolic, pyridinic, graphitic, amine, imine or nitric functionalities. Further XPS studies showed (fitting referenced with J. Vac. Sci. Technol. A 38 (3) May/June 2020; doi: 10.1116/1.5135923) that the N(1s) peak of FIG. 2 could be attributed primarily to pyridinic N (53.35%) and amine or Ngr (34.01%) nitrogen. [Ngr is graphitic nitrogen, a nitrogen substituting a carbon in the graphene layer as shown in the fitting reference]. By comparison, the spectrum from the sample of FIG. 1 could not assign the small N peak to any particular chemical species and gave a poor-quality signal due to the low quantity of N present.

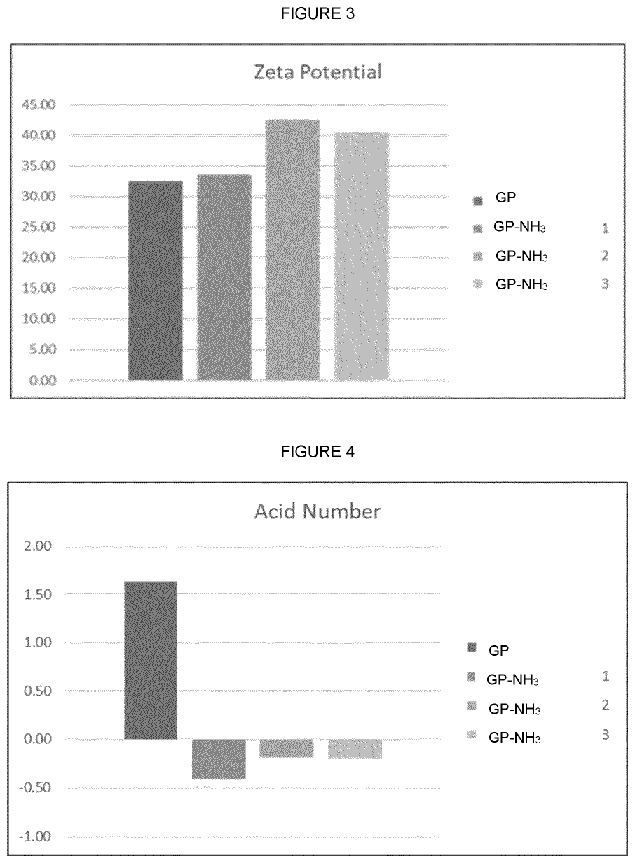

FIGS. 3 and 4 confirm that the plasma treatment of graphene particles (GP) with ammonia (GP-NH₃) was successful in providing nitrogen functionalisation. These figures show the zeta potential increased after treatment (FIG. 3), and the acid number went negative after treatment (FIG. 4). Note that the references 1, 2 and 3 refer to different batches of ammonia treated (nitrogen functionalised) graphene particles.

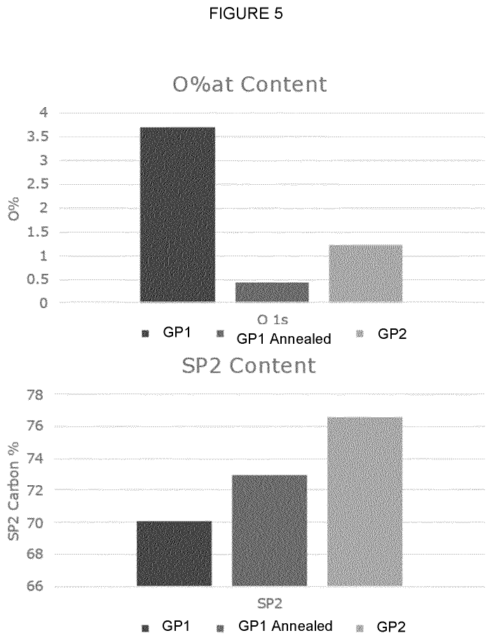

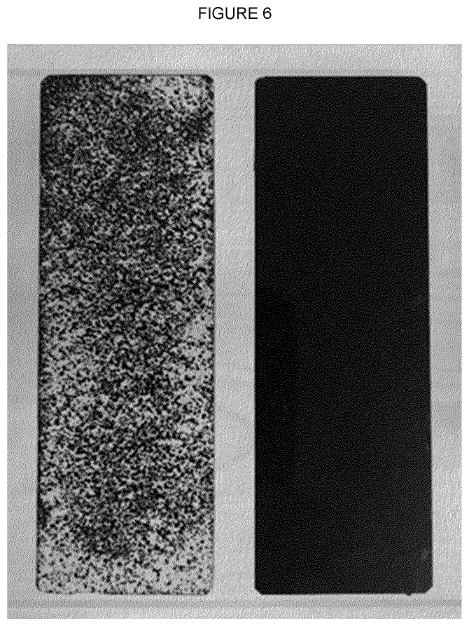

FIG. 5 shows the effect of annealing on graphene particles. In the upper graph, the change in O at % is monitored. The left bar shows unannealed graphene particles (GP1) having 3.7 O at %. The middle bar shows annealing treatment at 800° C. reduced the amount of oxygen to less than 0.5 at %. The rightmost bar shows untreated sample of graphene particles having an intrinsically low oxygen content, of less than 1.5 at %.

As can be seen in the lowermost graph, the annealing treatment only slightly impacted the sp² content. In particular, the annealing treatment increased the sp² carbon content by around 3%. The graphene particles having intrinsically low oxygen content had higher sp² carbon content, around 77%.

FIG. 6 shows that graphene particles with functionalisation as described herein (i.e. having less than 4 at % oxygen and more than 3 at % nitrogen) show good dispersibility in a polymer matrix material.

In particular, the sample containing graphene particles according to the invention (right) are consistently black across the sample, while the sample containing graphene particles not functionalised according to the invention (left) shows reduced dispersibility. In particular, the reduced dispersibility can be observed by inconsistent coloration across the sample, indicating the presence of clumps or areas of higher and areas of lower graphene particle concentrations. In contrast, no such clumping can be seen in the sample on the right, indicative of consistent graphene particle dispersion. The left and right samples contain the same (around 1% by mass) loading of graphene particles.

### Examples

### Experiment 1

In a first set of experiments, the dispersibility of graphene particles as used in the present invention was assessed.

Graphene particles according to the claims were combined with a polymer matrix material and stirred manually.

Visually, it was observed that the polymer matrix material became consistently blackened following stirring. See e.g. FIG. 6.

The results supported that the graphene particles according to the claims dispersed well in a polymer matrix material.

### Experiment 2

In a second set of experiments, the effect of low oxygen content and nitrogen functionalisation of the graphene particles on resistivity was assessed.

Two inks containing graphene particles were prepared. A first ink was nitrogen functionalised using ammonia plasma treatment, but also had high oxygen content (more than 4 at %). A second ink was prepared having both low oxygen content and was plasma treated to incorporate nitrogen functionalisation, as described herein.

In the following, the polymer matrix material and other components were kept constant. The mass content of graphene particles in each ink was adjusted slightly to achieve inks having comparable viscosity. The difference in mass content is not expected to have a significant effect on resistivity.

| | Graphene particle | | |
|---|---|---|---|
| Ink | functionalisation | Viscosity (Pa · s) | Resistivity (Ω) |
| Comparative | High oxygen, with | 14.87 | 314 |
| Example 1 | nitrogen | | |
| | functionalisation | | |
| Example 1 | Low oxygen, with | 15.13 | 17.06 |
| | nitrogen | | |
| | functionalisation | | |

For direct comparison, the inks of Comparative Example 1 and Example 1 were screen printed and a normalised resistivity calculated. The results were as follows:

| Ink | Normalised Resistivity (50 micron Ω) |
|---|---|
| Comparative Example 1 | 57 |
| Example 1 | 14.7 |

It can be seen that optimal resistivity is achieved by using graphene particles having both low oxygen content and nitrogen functionalisation.

In general, it is favourable to improve battery life and heat-up times for commercial applications. This means that smaller power supplies can be used with increased time between charges or generally less power consumption. The inventors have found that certain inks prepared according to the present invention can achieve an increase in temperature from ambient temperature to 60° C. in just 30 s at an applied voltage under 24V. Of course, different heating rates can be recorded at different applied voltages. Further, the heating pads of the invention give unexpectedly long run times for mAh battery packs i.e. an extended battery life. This is thought to be due to the ability of the heating pads to maintain their temperature at lower voltage. Accordingly, heating pads of the invention show properties well-suited for commercial applications.

In respect of numerical ranges disclosed in the present description it will of course be understood that in the normal way the technical criterion for the upper limit is different from the technical criterion for the lower limit, i.e. the upper and lower limits are intrinsically distinct proposals.

For the avoidance of doubt it is confirmed that in the general description above, in the usual way the proposal of general preferences and options in respect of different features of the heatable garments, bedding and fabrics and methods described above constitutes the proposal of general combinations of those general preferences and options for the different features, insofar as they are combinable and compatible and are put forward in the same context.

The terminology above used in relation to garments and bedding is based on normal U.K. English usage, and the skilled reader will understand that certain of the above items may be given different names in other English-speaking countries, such as the U.S.A.

1. A heating pad comprising graphene particles dispersed in a polymer matrix material, wherein the graphene particles have an oxygen content of less than 4 at % and a nitrogen content of at least 3 at %, wherein the oxygen and nitrogen contents may be measured by XPS.

2. The heating pad according to claim 1, wherein the oxygen content is less than 2 at % or less than 1.5 at %.

3. The heating pad according to claim 1, wherein the oxygen content is less than 1 at %.

4. The heating pad according to claim 1, wherein the oxygen content is less than 0.5 at %.

5. The heating pad according to claim 1, wherein the graphene particles have a nitrogen content of at least 5 at %.

6. The heating pad according to claim 1, wherein the graphene particles have a nitrogen content of no more than 21 at %.

7. The heating pad according to claim 1, wherein the graphene particles have a nitrogen content of between 10 at % and 20 at %.

8. (canceled)

9. The heating pad according to claim 1, wherein the graphene particles have at least one of a zeta potential at pH3 in a range of at least 3 mV and an acid number of less than zero.

10. The heating pad according to claim 1, comprising an electrically insulating covering layer bonded to the heating pad and an electrically insulating covering layer, overlaying and bonded to the heating pad.

11. The heating pad according to claim 10, wherein the electrically insulating covering layers comprise a material which is the same as the polymer matrix material.

12. The heating pad according to claim 1, wherein the graphene particles are graphene nanoplatelets having an average of 2 to 5 graphene layers per particle.

13. The heating pad according to claim 1, wherein the heating pad comprises multiple stacked layers of conductive material.

14. The heating pad according to claim 1, wherein an average thickness of the heating pad is 300 μm or less.

15. The heating pad according to claim 1, wherein the polymer matrix material is an elastic material.

16. A heatable garment, comprising a garment body and a heating pad according to claim 1 adhered to at least a portion of the garment body, optionally wherein the heatable garment comprises a temperature control system to control the temperature of the heating pad.

17. (canceled)

18. The heatable garment according to claim 16, wherein the heatable garment comprises two or more of said heating pads, and the control system is configured to allow independent control over the temperature of each of said two or more of said heating pads,
wherein said two or more of said heating pads target different muscle groups, wherein the control system is configured to allow the temperature of said two or more of said heating pads to be independently adjusted according to the muscle group.

19. (canceled)

20. A method of making a heatable garment according to claim 16, comprising:
providing a clothing material; and
depositing one or more layers of a conductive material onto at least a portion of the clothing material to form a heating pad;
wherein the conductive material comprises graphene particles dispersed in a polymer matrix material, and wherein the graphene particles have an oxygen content of less than 4 at % and a nitrogen content of at least 3 at %.

21. The method according to claim 20, comprising:
providing said clothing material;
depositing an electrically-insulating layer onto at least a portion of the clothing material; and
depositing one or more layers of said conductive material onto the electrically-insulating layer.

22. The method according to claim 20, further comprising depositing an electrically-insulating covering layer onto said one or more layers of conductive material.

23. (canceled)

24. (canceled)

25. (canceled)
